(19) United States
(12) Patent Application Publication
(10) Pub. No.: US 2025/0303729 A1
(43) Pub. Date: Oct. 2, 2025

(54) NEGATIVE PRESSURE REGULATION VALVE AND INKJET RECORDING APPARATUS INCLUDING THE SAME

(71) Applicant: KYOCERA Document Solutions Inc., Osaka (JP)

(72) Inventors: Hideki ISHIDA, Osaka (JP); Kenichi SATAKE, Osaka (JP); Shogo YONEDA, Osaka (JP); Shun TSUBOI, Osaka (JP)

(73) Assignee: KYOCERA Document Solutions Inc., Osaka (JP)

(21) Appl. No.: 19/085,518

(22) Filed: Mar. 20, 2025

(30) Foreign Application Priority Data
Mar. 28, 2024 (JP) 2024-052908

(51) Int. Cl. B41J 2/175; B41J 2/14

(52) U.S. Cl. CPC B41J 2/17596; B41J 2/14048

(57) ABSTRACT

A negative pressure regulation valve includes an inflow-side pressure chamber including a liquid inflow hole, an outflow-side pressure chamber including a liquid outflow hole, a communication hole, and a valve member inserted in the communication hole and movable, in accordance with change of pressure inside the outflow-side pressure chamber, to a closing position for closing the communication hole and an opening position for opening the communication hole. The outflow-side pressure chamber includes, as the liquid outflow hole, a first outflow hole formed below the communication hole and a second outflow hole formed above the communication hole. As seen from a communication direction of the communication hole, a first line extending in an outflow direction of liquid from the first outflow hole and a second line extending in an outflow direction of liquid from the second outflow hole do not coincide with each other.

### INCORPORATION BY REFERENCE

This application is based on and claims the benefit of priority from Japanese Patent Application No. 2024-052908 filed on Mar. 28, 2024, the contents of which are hereby incorporated by reference.

### BACKGROUND

The present disclosure relates to a negative pressure regulation valve for use in an inkjet recording apparatus, and an inkjet recording apparatus including the negative pressure regulation valve.

In inkjet recording apparatuses, it is important to constantly maintain the ink ejection state and conditions to ensure high print quality. For this purpose, a configuration is adopted in which an ink flow path connecting an ink container and a recording head is provided with a pressure regulating portion (a negative pressure regulation valve, a damper, or the like) that regulates pressure by storing ink.

### SUMMARY

According to one aspect of the present disclosure, a negative pressure regulation valve is connected to a liquid flow path that allows communication between a liquid reservoir portion, which contains a liquid, and a liquid ejection portion, which ejects the liquid. The negative pressure regulation valve includes an inflow-side pressure chamber, an outflow-side pressure chamber, a communication hole, and a valve member. The inflow-side pressure chamber includes a liquid inflow hole that communicates with a liquid inflow path that is the liquid flow path on a side of the liquid reservoir portion. The outflow-side pressure chamber includes a liquid outflow hole that communicates with a liquid outflow path that is the liquid flow path on a side of the liquid ejection portion. The communication hole allows communication between the inflow-side pressure chamber and the outflow-side pressure chamber. The valve member is inserted in the communication hole and movable, in accordance with change of pressure inside the outflow-side pressure chamber, between a closing position for closing the communication hole and an opening position for opening the communication hole. The outflow-side pressure chamber includes, as the liquid outflow hole, a first outflow hole formed below the communication hole and a second outflow hole formed above the communication hole. As seen from a communication direction of the communication hole, a first line extending in an outflow direction of liquid from the first outflow hole and a second line extending in an outflow direction of liquid from the second outflow hole do not coincide with each other.

### BRIEF DESCRIPTION OF THE DRAWINGS

FIG. 1 is an explanatory diagram schematically illustrating a configuration of a printer as an inkjet recording apparatus according to one embodiment of the present disclosure.

FIG. 2 is a plan view of a recording portion that the printer includes.

FIG. 3 is a schematic configuration diagram illustrating an arrangement of an ink flow path 40, a negative pressure regulation valve, and a recording head, the latter two being connected to the ink flow path.

FIG. 4 is a side sectional view of the negative pressure regulation valve.

FIG. 5 is a schematic diagram illustrating the negative pressure regulation valve of the present embodiment as seen from the front side, the diagram illustrating how ink is discharged during an execution of a suction purge process.

FIG. 6 is a schematic diagram illustrating a modified example of the negative pressure regulation valve of the present embodiment as seen from the front side, the diagram illustrating how the ink is discharged during an execution of the suction purge process.

FIG. 7 is a schematic diagram illustrating another modified example of the negative pressure regulation valve of the present embodiment as seen from the front side, the diagram illustrating how the ink is discharged during an execution of the suction purge process.

### DETAILED DESCRIPTION

### 1. Configuration of Inkjet Recording Apparatus

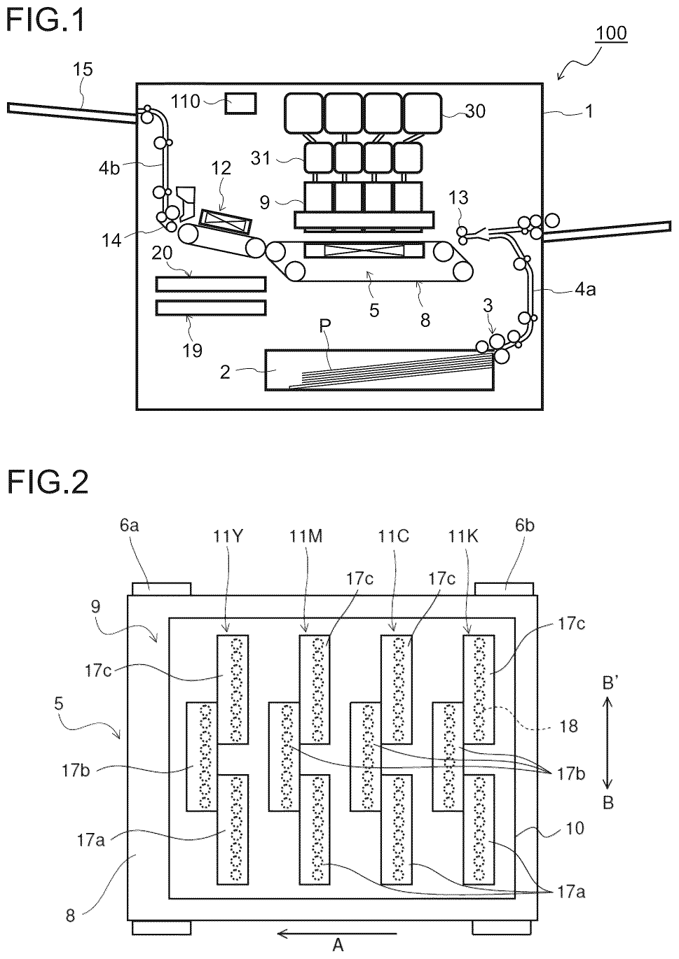

Hereinafter, an embodiment of the present disclosure will be described with reference to the accompanying drawings. FIG. 1 is an explanatory diagram schematically illustrating a configuration of a printer 100 as an inkjet recording apparatus according to one embodiment of the present disclosure. The printer 100 includes a sheet feeding cassette 2 that is a sheet storage portion. The sheet feeding cassette 2 is disposed in a lower part inside a printer main body 1. Inside the sheet feeding cassette 2, a sheet P is stored as one example of a recording medium.

On a downstream side of the sheet feeding cassette 2 in a sheet conveyance direction, that is, on an upper right side of the sheet feeding cassette 2 in FIG. 1, a sheet feeding device 3 is disposed. By the sheet feeding device 3, sheets P are sent out, one by one separately, toward the upper right side of the sheet feeding cassette 2 in FIG. 1.

The printer 100 includes a first sheet conveyance path 4a disposed inside thereof. The first sheet conveyance path 4a is disposed, with respect to the sheet feeding cassette 2, on the upper right side, toward which a sheet P is fed from the sheet feeding cassette 2. A sheet P sent out from the sheet feeding cassette 2 is, by the first sheet conveyance path 4a, conveyed vertically upward along a side surface of the printer main body 1.

At a downstream end of the first sheet conveyance path 4a in the sheet conveyance direction, a pair of registration rollers 13 are disposed. Furthermore, immediately close to the pair of registration rollers 13 on a downstream side thereof in the sheet conveyance direction, a first conveyance unit 5 and a recording portion 9 are disposed. A sheet P sent out from the sheet feeding cassette 2 passes through the first sheet conveyance path 4a and reaches the pair of registration rollers 13. The pair of registration rollers 13, while correcting skew feeding of the sheet P, send out the sheet P toward the first conveyance unit 5 (in particular, a first conveyance belt 8 which will be described later), with timing coordinated with an ink ejecting operation that the recording portion 9 executes.

FIG. 2 is a plan view of the recording portion 9. The recording portion 9 includes a head housing 10 and line heads 11Y, 11M, 11C, and 11K. The line heads 11Y to 11K are held in the head housing 10 at such a height that maintains a predetermined distance (e.g., 1 mm) from a conveyance surface of the first conveyance belt 8, which is an endless belt stretched by a plurality of rollers including a driving roller 6a, a driven roller 6b, and a tension roller (unillustrated). The driving roller 6a causes the first conveyance belt 8 to rotate in the conveyance direction (an arrow-A direction) of a sheet P.

The line heads 11Y to 11K each have a plurality of (here, three) recording heads 17a to 17c. The recording heads 17a to 17c are arranged in a staggered manner along a sheet width direction (an arrow-BB′ direction) that is orthogonal to the sheet conveyance direction (the arrow-A direction). The recording heads 17a to 17c each have a plurality of ink ejection ports 18 (nozzles). The ink ejection ports 18 are arranged at regular intervals in a recording-head width direction, that is, the sheet width direction (the arrow-BB′ direction). From each of the line heads 11Y to 11K, via the ink ejection ports 18 of the recording heads 17a to 17c, ink in yellow (Y), magenta (M), cyan (C), or black (K) is ejected toward the sheet P conveyed by the first conveyance belt 8.

The recording heads 17a to 17c constituting each of the line heads 11C to 11K are supplied, from an ink container 30 (see FIG. 1), with ink in one of the four colors (yellow, magenta, cyan, and black) corresponding to the colors of the line heads 11C to 11K. Between the ink container 30 and the recording heads 17a to 17c, a negative pressure regulation valve 31 (see FIG. 1) is coupled. A detailed configuration of the negative pressure regulation valve 31 will be described later.

Based on a control signal from a control device 110 (see FIG. 1), each of the recording heads 17a to 17c, in accordance with image data received from an external computer, ejects ink through the ink ejection ports 18 toward a sheet P, which is conveyed by being held by suction on the conveyance surface of the first conveyance belt 8. Thereby, on the sheet P held on the first conveyance belt 8, a color image is formed by superimposing inks in yellow, magenta, cyan, and black on one another.

Referring back to FIG. 1, the sheet P having been sent out by the pair of registration rollers 13 to the first conveyance unit 5 is conveyed by the first conveyance belt 8 to a position at which it faces the recording portion 9 (in particular, the recording heads 17a to 17c, which will be described later). By the recording portion 9 ejecting ink onto the sheet P, an image is recorded on the sheet P. The ejection of ink in the recording portion 9 is controlled by the control device 110 incorporated in the printer 100.

In the sheet conveyance direction, on a downstream side (a left side in FIG. 1) of the first conveyance unit 5, a second conveyance unit 12 is disposed. The sheet P, having had an image recorded thereon by the recording portion 9, is then sent to the second conveyance unit 12. The ink having been ejected onto a surface of the sheet P is dried while the sheet P is passing through the second conveyance unit 12.

In the sheet conveyance direction, at a position that is downstream of the second conveyance unit 12 and close to a left side surface of the printer main body 1, a decurler portion 14 is disposed. The sheet P, having had the ink dried through the second conveyance unit 12, is then sent to the decurler portion 14, where a curl having been generated in the sheet P is corrected.

In the sheet conveyance direction, at a position that is downstream of (in FIG. 1, above) the decurler portion 14, a second sheet conveyance path 4b is disposed. After passing through the decurler portion 14, if no duplex recording is to be performed, the sheet P passes through the second sheet conveyance path 4b and is discharged onto a sheet discharge tray 15 disposed on an outside of the left side surface of the printer 100.

Further, below the second conveyance unit 12, a maintenance unit 19 and a cap unit 20 are disposed. When a purge is executed, the maintenance unit 19 horizontally moves to a position under the recording portion 9, wipes ink discharged through the ink ejection ports 18 of the recording heads 17a to 17c, and collects the wiped ink. Here, a purge refers to an operation of discharging thickened ink, foreign matter, bubbles, etc., from inside the ink ejection ports 18 by forcibly discharging ink from the ink ejection ports 18 of the recording heads 17a to 17c. To cap ink ejection surfaces of the recording heads 17a to 17c, the cap unit 20 horizontally moves to a position under the recording portion 9, and then further moves upward to be attached to lower surfaces of the recording heads 17a to 17c.

### 2. Configuration of Ink Flow Path including Negative Pressure Regulation Valve

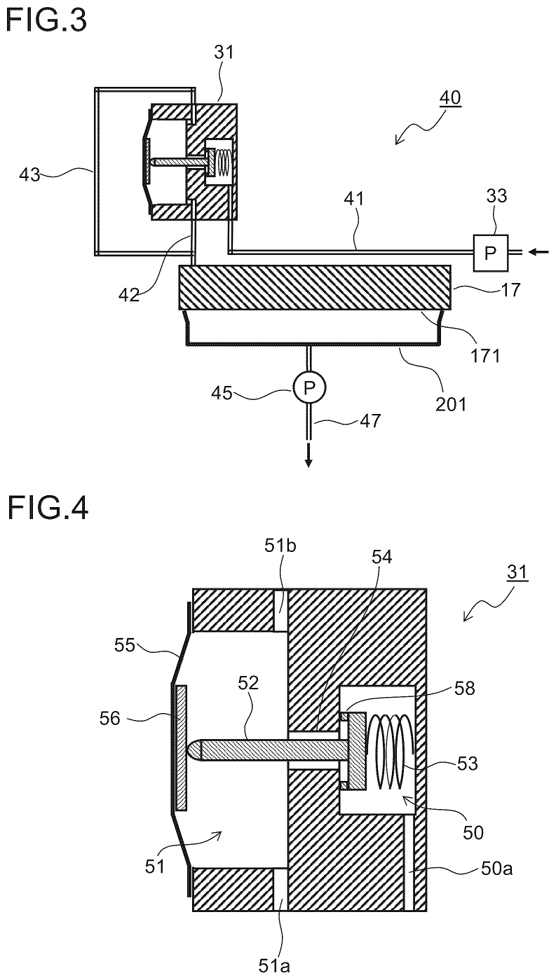

FIG. 3 is a schematic configuration diagram illustrating an arrangement of an ink flow path 40, a negative pressure regulation valve 31, and a recording head 17, the latter two being connected to the ink flow path 40. In the following description, the recording heads 17a to 17c will be simply referred to as the recording head 17. Further, up-down directions in FIGS. 3 and 4 correspond to a vertical direction (a direction of gravity).

The ink flow path 40 includes an ink inflow path 41, a first outflow path 42, and a second outflow path 43. Between the ink inflow path 41 and both the first outflow path 42 and the second outflow path 43, the negative pressure regulation valve 31 is connected.

Ink having been introduced from the ink container 30 (see FIG. 1) into the ink flow path 40 is supplied to the recording head 17 via the ink inflow path 41, the negative pressure regulation valve 31, the first outflow path 42, and the second outflow path 43. To the ink inflow path 41, a pressure pump 33 is connected. The pressure pump 33 maintains pressure inside an inflow-side pressure chamber 50 (see FIG. 4) at a constant pressure that is higher than pressure inside an outflow-side pressure chamber 51 (see FIG. 4).

Note that a configuration may be adopted in which the pressure pump 33 is not provided and the ink container 30 is disposed at a position higher than the negative pressure regulation valve 31 to use hydraulic head pressure of ink to maintain constant pressure inside the inflow-side pressure chamber 50. In a case where a sub tank (unillustrated) is disposed between the ink container 30 and the negative pressure regulation valve 31, the sub tank is located at a position higher than the negative pressure regulation valve 31.

To the recording head 17, a cap 201 is attached. The cap 201 is supported in the cap unit 20 (see FIG. 1), and is attached to an ink ejection surface (nozzle surface) 171 of the recording head 17 when no printing process is to be executed for a certain period of time or longer. With the cap 201 attached, the ink ejection surface 171 of the recording head 17 is maintained in a sealed state. In the cap 201, a flow path (unillustrated) is provided that communicates with atmosphere. This flow path is openable and closable so that change of temperature in a space between the ink ejection surface 171 and the cap 201 will not cause excessive change of pressure in ink ejection ports (nozzles) 18 of the recording head 17. To the cap 201, a suction pump 45 and a waste ink discharge path 47 are connected.

In the printer 100, in order to prevent insides of the ink ejection ports 18 (see FIG. 2) of the recording head 17 from becoming dry and to remove thickened ink, foreign matter, etc., from the insides of the ink ejection ports 18, when printing is started after a long period of stop, and between printing operations, the suction pump 45 performs, with the cap 201 attached to the ink ejection surface 171 and the flow path communicating with atmosphere closed, a suction purging process by sucking air from the space (sealed space) between the ink ejection surface 171 and the cap 201 to forcibly suck out ink from all the ink ejection ports 18 of the recording head 17, so as to be ready for the next printing operation. The ink (purged ink) having been sucked out from the recording head 17 into an inside of the cap 201 is discharged by the suction pump 45 to an outside of the cap 201, and is then collected via the waste ink discharge path 47 in a waste ink tank (unillustrated).

The suction purge process is also executed when initially filling the ink flow path 40 with an initial filling liquid or ink, when replacing the initial filling liquid in the ink flow path 40 with the ink, and when discharging air, foreign matter, etc., from inside the ink flow path 40.

### 3. Configuration of Negative Pressure Regulation Valve

FIG. 4 is a side sectional view of the negative pressure regulation valve 31 in the present embodiment of the present disclosure. The negative pressure regulation valve 31 stores therein ink that flows in the ink flow path 40, and also functions as a pressure regulation valve that opens and closes the ink flow path 40 in accordance with pressure on a side of the recording head 17. The negative pressure regulation valve 31 includes the inflow-side pressure chamber 50, the outflow-side pressure chamber 51, a valve member 52, and an opening/closing pressure regulation spring 53.

The inflow-side pressure chamber 50 includes an ink inflow hole 50a to which the ink inflow path 41 is coupled. The inflow-side pressure chamber 50 has a predetermined capacity for storing ink having flowed in through the ink inflow hole 50a. The inflow-side pressure chamber 50 communicates with the outflow-side pressure chamber 51 via a communication hole 54. In the inflow-side pressure chamber 50, one end part (a large-diameter part) of the valve member 52, which is capable of closing the communication hole 54, and the opening/closing pressure regulation spring 53 are housed.

The outflow-side pressure chamber 51 includes a first outflow hole 51a, to which the first outflow path 42 is coupled, a second outflow hole 51b, to which the second outflow path 43 is coupled, and a diaphragm portion 55. The outflow-side pressure chamber 51 stores ink having flowed in through the communication hole 54. The outflow-side pressure chamber 51 has a capacity that changes with displacement of the diaphragm portion 55.

The first outflow hole 51a is connected, via the first outflow path 42, to the recording head 17. The first outflow hole 51a is formed at a position lower than the communication hole 54. In the present embodiment, the first outflow hole 51a is formed in a lower end part of the outflow-side pressure chamber 51.

The second outflow hole 51b is connected, via the second outflow path 43, to the recording head 17. The second outflow hole 51b is formed at a position higher than the communication hole 54. In the present embodiment, the second outflow hole 51b is formed in an upper end part of the outflow-side pressure chamber 51. In the outflow-side pressure chamber 51, the other end part (a small-diameter part) of the valve member 52 and a pressure receiving plate 56 are housed.

The valve member 52 is movable, in accordance with change of pressure inside the outflow-side pressure chamber 51, to a closing position for closing the communication hole 54, and an opening position for opening the communication hole 54 against a biasing force of the opening/closing pressure regulation spring 53. To an opening part of the communication hole 54 on a side of the inflow-side pressure chamber 50, an O ring 58 is attached. When the valve member 52 is located at the closing position, the one end part (the large-diameter part) of the valve member 52 is in contact with the O ring 58. When the valve member 52 is located at the opening position, the one end part (the large-diameter part) of the valve member 52 is separated from the O ring 58.

The diaphragm portion 55 is formed of a flexible resin film having a multi-layer structure. The diaphragm portion 55 is fixed to an outer side surface of the outflow-side pressure chamber 51 with a predetermined slack. The diaphragm portion 55 is displaced in accordance with change of pressure inside the outflow-side pressure chamber 51, thereby changing the capacity of the outflow-side pressure chamber 51.

The pressure receiving plate 56 is secured to an inner side surface (a resin layer facing the outflow-side pressure chamber 51) of the diaphragm portion 55, and is integrally movable with the diaphragm portion 55. At a central position on the pressure receiving plate 56, the other end part (the small-diameter part) of the valve member 52 inserted through the communication hole 54 is in contact with the pressure receiving plate 56. On the pressure receiving plate 56, a force acts, due to the biasing force of the opening/closing pressure regulation spring 53, via the valve member 52, in a direction of outwardly displacing (inflating) the diaphragm portion 55.

When ink is consumed in the recording head 17, and the pressure is reduced inside the outflow-side pressure chamber 51, the diaphragm portion 55 is inwardly displaced (deflated). Thereby, the pressure receiving plate 56, against the biasing force of the opening/closing pressure regulation spring 53, pushes the valve member 52 into the inflow-side pressure chamber 50 (the opening position) to open the communication hole 54. As a result, ink is supplied from the inflow-side pressure chamber 50 to the outflow-side pressure chamber 51. Then, when the pressure inside the outflow-side pressure chamber 51 reaches a predetermined negative pressure, the valve member 52 is pushed back into the outflow-side pressure chamber 51 (the closing position) to close the communication hole 54, and the supply of ink from the inflow-side pressure chamber 50 to the outflow-side pressure chamber 51 is stopped. In this manner, pressure is regulated to supply ink to the recording portion 9.

In an execution of the suction purge process, the ink ejection surface 171 of the recording head 17 is covered with the cap 201, and the suction pump 45 sucks air from the space (the sealed space) between the ink ejection surface 171 and the cap 201 to generate a negative pressure. Thereby, the valve member 52 moves to the opening position to open the communication hole 54, allowing the liquid (the ink or the initial filling liquid) inside the recording head 17 to be discharged through the ink ejection ports 18.

At this time, the outflow-side pressure chamber 51 inside the negative pressure regulation valve 31 has a negative pressure, and the valve member 52 is pushed by the diaphragm portion 55. As a result, the valve member 52 moves into the inflow-side pressure chamber 50 against the biasing force of the opening/closing pressure regulation spring 53 to open the communication hole 54, allowing communication between the inflow-side pressure chamber 50 and the outflow-side pressure chamber 51. Thereby, the liquid flows from the ink container 30, via the ink inflow path 41, the negative pressure regulation valve 31, the first outflow path 42, and the second outflow path 43, into the recording head 17.

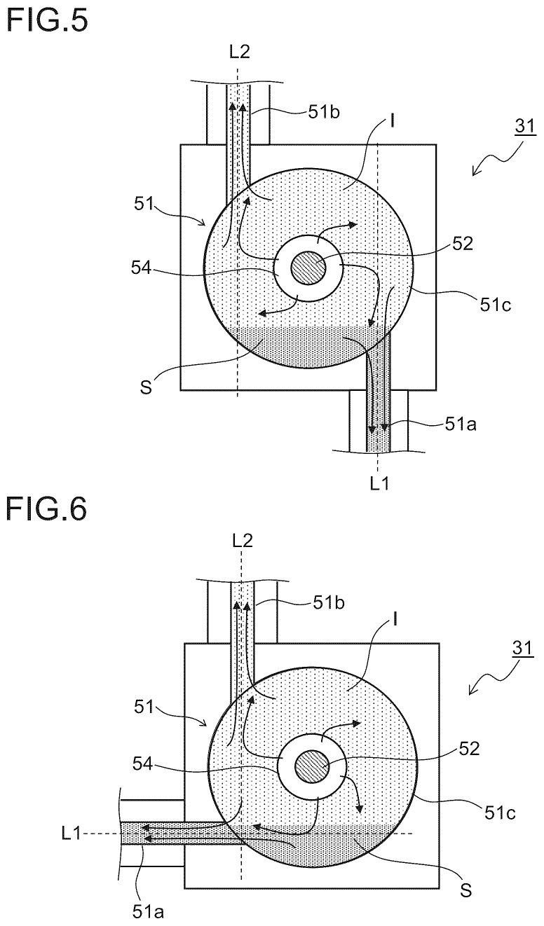

FIG. 5 is a schematic diagram illustrating the negative pressure regulation valve 31 of the present embodiment as seen from the front side (the left side in FIG. 4), the diagram illustrating how ink I is discharged during an execution of a suction purge process. As shown in FIG. 5, in the negative pressure regulation valve 31 of the present embodiment, as seen from a communication direction of the communication hole 54 (a direction perpendicular to the sheet plane of FIG. 5), a first line L1 extending in an outflow direction of liquid from the first outflow hole 51a provided at a lower part of the outflow-side pressure chamber 51 and a second line L2 extending in an outflow direction of liquid from the second outflow hole 51b provided at an upper part of the outflow-side pressure chamber 51 do not coincide with each other. More specifically, the first line L1 and the second line L2 are parallel to each other, and the first outflow hole 51a and the second outflow hole 51b are disposed at positions that deviate from a same single line.

Further, an inner wall surface 51c of the outflow-side pressure chamber 51 is circular-shaped as seen from the communication direction of the communication hole 54, and the communication hole 54 is formed at a center of the outflow-side pressure chamber 51 as seen from the communication direction. Furthermore, as seen from the communication direction of the communication hole 54, the first line L1 and the second line L2 are not perpendicular with respect to the inner wall surface 51c of the outflow-side pressure chamber 51.

Solid matter S such as a solidified ink component, foreign matter, etc., contained in the ink I that is caused by the suction purge process to flow from the communication hole 54 into the outflow-side pressure chamber 51 stays in the lower part of the outflow-side pressure chamber 51. This solid matter S, together with the ink I flowing in a clockwise direction around the communication hole 54, moves out from the first outflow hole 51a formed at the lower part of the outflow-side pressure chamber 51, via the first outflow path 42, into the recording head 17.

Further, air contained in the ink I (or the initial filling liquid) that flows into the outflow-side pressure chamber 51 stays in the upper part of the outflow-side pressure chamber 51. Thus, the air flows out from the second outflow hole 51b formed at the upper part of the outflow-side pressure chamber 51, via the second outflow path 43, into the recording head 17.

According to the configuration of the present embodiment, the air inside the outflow-side pressure chamber 51 smoothly and efficiently flows out from the second outflow hole 51b, which is disposed above the communication hole 54, via the second outflow path 43, and thus does not remain in the outflow-side pressure chamber 51. Thus, it is possible to reduce a flow amount of initial filling liquid in a case where the ink flow path 40 is filled with the initial filling liquid prior to shipment of the printer 100.

Further, due to the arrangement of the first outflow hole 51a and the second outflow hole 51b at positions that deviate from the same single line, when liquid flows out from the first outflow hole 51a and the second outflow hole 51b, inside the outflow-side pressure chamber 51, a liquid flow is generated to rotate in a constant direction (the clockwise direction in FIG. 5) around the communication hole 54. As a result, the following effects can be expected from the suction purge process.

In a case where the initial filling liquid in the ink flow path 40 is replaced with ink when installing the printer 100, together with the liquid flow rotating around the communication hole 54 inside the outflow-side pressure chamber 51, the initial filling liquid having a low density moves to the upper part of the outflow-side pressure chamber 51, whereas the ink having a high density moves to the lower part of the outflow-side pressure chamber 51. Thus, since the initial filling liquid flows out from the second outflow hole 51b via the second outflow path 43 smoothly and efficiently, the initial filling liquid does not remain inside the outflow-side pressure chamber 51. Thus, it is possible to reduce a flow amount of ink when replacing the initial filling liquid inside the ink flow path 40 with the ink.

In a case where ink component solidification or foreign matter intrusion occurs while the printer 100 is in use, the suction purge process is executed, so that the solid matter S, together with the flow of ink rotating around the communication hole 54 inside the outflow-side pressure chamber 51, smoothly and efficiently flows out from the first outflow hole 51a via the first outflow path 42, and thus does not remain in the outflow-side pressure chamber 51. Thus, it is possible to avoid the problem of the solid matter S being trapped in a space between the valve member 52 and the communication hole 54, preventing the valve member 52 from moving.

Further, the communication hole 54 (the valve member 52) does not exist on an extension of either the first line L1 extending in the outflow direction of the first outflow hole 51a or the second line L2 extending in the outflow direction of the second outflow hole 51b. More specifically, the communication hole 54 is disposed between the first line L1 and the second line L2.

With this arrangement, it becomes unlikely for liquid having flowed from the communication hole 54 into the outflow-side pressure chamber 51 to flow directly through the first outflow hole 51a and the second outflow hole 51b, and this makes it likely that a liquid flow will be generated to rotate around the communication hole 54 inside the outflow-side pressure chamber 51. Consequently, the solid matter S staying in the lower part of the outflow-side pressure chamber 51 can be discharged with improved efficiency.

Further, in the present embodiment, the communication hole 54 is formed at the center of the outflow-side pressure chamber 51 as seen from the communication direction of the communication hole 54. Thus, it becomes more likely that a liquid flow will be generated to rotate inside the outflow-side pressure chamber 51.

Note that, although in the present embodiment the communication hole 54 is formed at the center of the outflow-side pressure chamber 51 as seen from the communication direction of the communication hole 54, the communication hole 54 may be formed at a position that deviates from the center of the outflow-side pressure chamber 51. In that case, at least one of the communication hole 54 or the center of the outflow-side pressure chamber 51 as seen from the communication direction of the communication hole 54 is disposed between the first line L1 and the second line L2.

Further, vectors in the outflow directions of the first outflow hole 51a and the second outflow hole 51b have rotation directions that coincide with each other (the clockwise direction in FIG. 5) when considered as rotation vectors with respect to the communication hole 54 or the center of the outflow-side pressure chamber 51 as seen from the communication direction of the communication hole 54. Thereby, flows in the rotation direction around the communication hole 54 generated inside the outflow-side pressure chamber 51 when liquid flows out from the first outflow hole 51a and the second outflow hole 51b reinforce each other. Consequently, the solid matter S staying in the lower part of the outflow-side pressure chamber 51 can be discharged with further improved efficiency.

Further, in FIG. 5, the first line L1 extending in the outflow direction of the first outflow hole 51a and the second line L2 extending in the outflow direction of the second outflow hole 51b are not perpendicular with respect to the inner wall surface 51c of the outflow-side pressure chamber 51 as seen from the communication direction of the communication hole 54, and this arrangement makes it more likely that a liquid flow will be generated to rotate along the inner wall surface 51c of the outflow-side pressure chamber 51 when liquid flows out from the first outflow hole 51a and the second outflow hole 51b. Consequently, the solid matter S staying in the lower part of the outflow-side pressure chamber 51 can be discharged with still further improved efficiency.

Further, in FIG. 5, the inner wall surface 51c of the outflow-side pressure chamber 51 is formed to be circular-shaped as seen from the communication direction of the communication hole 54, and with this arrangement, there is no part where the liquid flow rotating along the inner wall surface 51c of the outflow-side pressure chamber 51 stays, and thus the liquid flow is likely to flow more smoothly.

Furthermore, in FIG. 5, the first outflow hole 51a and the second outflow hole 51b are disposed at positions that are point-symmetric with respect to the center (the communication hole 54) of the outflow-side pressure chamber 51 as seen from the communication direction of the communication hole 54. With this arrangement, a liquid flow is generated to rotate around the communication hole 54 inside the outflow-side pressure chamber 51 in a well-balanced manner, and this makes it possible to discharge the solid matter S staying in the lower part of the outflow-side pressure chamber 51 with still further improved efficiency.

FIG. 6 is a schematic diagram illustrating a modified example of the negative pressure regulation valve 31 of the present embodiment as seen from the front side. In the modified example shown in FIG. 6, the first outflow hole 51a is formed in a horizontal direction from the lower part of the outflow-side pressure chamber 51. That is, the first line L1 extending in the outflow direction of liquid from the first outflow hole 51a and the second line L2 extending in the outflow direction of liquid from the second outflow hole 51b are orthogonal to each other. In other respects, the configuration of the negative pressure regulation valve 31 is similar to what is shown in FIG. 4 and FIG. 5.

In the modified example shown in FIG. 6, as well, the first line L1 extending in the outflow direction of the first outflow hole 51a and the second line L2 extending in the outflow direction of the second outflow hole 51b do not coincide with each other, and neither the communication hole 54 (the valve member 52) nor the center of the outflow-side pressure chamber 51 exists on extensions of the first line L1 and the second line L2. Further, the vectors in the outflow directions of the first outflow hole 51a and the second outflow hole 51b have rotation directions that coincide with each other when considered as rotation vectors with respect to the communication hole 54 or the center of the outflow-side pressure chamber 51.

Further, the inner wall surface 51c of the outflow-side pressure chamber 51 is circular-shaped as seen from the communication direction of the communication hole 54, and the communication hole 54 is formed at the center of the outflow-side pressure chamber 51 as seen from the communication direction. Further, as seen from the communication direction of the communication hole 54, the first line L1 and the second line L2 are not perpendicular with respect to the inner wall surface 51c of the outflow-side pressure chamber 51.

With this arrangement, when liquid flows out from the first outflow hole 51a and the second outflow hole 51b, a liquid flow is generated inside the outflow-side pressure chamber 51 to rotate around the communication hole 54 (the valve member 52). Consequently, when discharging the ink I from the outflow-side pressure chamber 51, the solid matter S staying in the lower part of the outflow-side pressure chamber 51 can be discharged with improved efficiency.

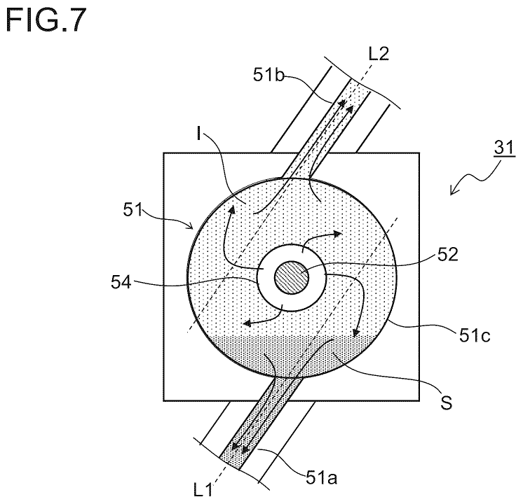

FIG. 7 is a schematic diagram illustrating another modified example of the negative pressure regulation valve 31 of the present embodiment as seen from the front side. In the modified example shown in FIG. 7, the first outflow hole 51a and the second outflow hole 51b are formed respectively at a lowermost part and an uppermost part of the outflow-side pressure chamber 51. In other respects, the configuration of the negative pressure regulation valve 31 is similar to what is shown in FIG. 4 and FIG. 5.

In the modified example shown in FIG. 7, as well, the first line L1 extending in the outflow direction of the first outflow hole 51a and the second line L2 extending in the outflow direction of the second outflow hole 51b do not coincide with each other, and neither the communication hole 54 (the valve member 52) nor the center of the outflow-side pressure chamber 51 exists on extensions of the first line L1 and the second line L2. Further, as for the vectors in the outflow directions of the first outflow hole 51a and the second outflow hole 51b, when considered as rotation vectors with respect to the communication hole 54 or the center of the outflow-side pressure chamber 51, their rotation directions coincide with each other.

Further, the inner wall surface 51c of the outflow-side pressure chamber 51 is circular-shaped as seen from the communication direction of the communication hole 54, and the communication hole 54 is formed at the center of the outflow-side pressure chamber 51 as seen from the communication direction. Further, as seen from the communication direction of the communication hole 54, the first line L1 and the second line L2 are not perpendicular with respect to the inner wall surface 51c of the outflow-side pressure chamber 51. Furthermore, the first outflow hole 51a and the second outflow hole 51b are disposed at positions that are point-symmetric with respect to the center (the communication hole 54) of the outflow-side pressure chamber 51 as seen from the communication direction of the communication hole 54.

With this arrangement, when liquid flows out from the first outflow hole 51a and the second outflow hole 51b, a liquid flow is generated inside the outflow-side pressure chamber 51 to rotate around the communication hole 54 (the valve member 52). Consequently, when discharging the ink I from the outflow-side pressure chamber 51, the solid matter S staying in the lower part of the outflow-side pressure chamber 51 can be discharged with improved efficiency.

Moreover, in FIG. 7, the first outflow hole 51a and the second outflow hole 51b are disposed respectively at the lower end part and the upper end part of the outflow-side pressure chamber 51. With this arrangement, during outflow, the flow generated inside the outflow-side pressure chamber 51 in the rotation direction around the communication hole 54 and discharge performance due to density difference between the ink I and the solid matter S reinforce each other, allowing the solid matter S to be discharged with improved efficiency.

It should be understood that the present disclosure is not limited to the above embodiments, and various modifications are possible within the scope of the present disclosure. For example, exemplified in the above embodiments as components connected to the ink flow path 40 are the recording head 17, the negative pressure regulation valve 31, and the suction pump 45, but the present disclosure is applicable to configurations where other components are connected to the ink flow path 40.

Further, described in the above embodiments is an example where used as an inkjet recording apparatus is a color printer which records color images using inks in four colors, but the ink supply unit of the present embodiment is usable also in a case where a monochrome printer is used which records a monochrome image using a black ink.

The present disclosure is usable in a negative pressure regulation valve connected between a liquid reservoir portion such as an ink container and a liquid ejection portion such as a recording head, and in an inkjet recording apparatus such as an inkjet printer that includes the negative pressure regulation valve.

What is claimed is:

1. A negative pressure regulation valve connected to a liquid flow path that allows communication between a liquid reservoir portion, which contains a liquid, and a liquid ejection portion, which ejects the liquid, the negative pressure regulation valve comprising:
an inflow-side pressure chamber including a liquid inflow hole that communicates with a liquid inflow path that is the liquid flow path on a side of the liquid reservoir portion;
an outflow-side pressure chamber including a liquid outflow hole that communicates with a liquid outflow path that is the liquid flow path on a side of the liquid ejection portion;
a communication hole that allows communication between the inflow-side pressure chamber and the outflow-side pressure chamber; and
a valve member inserted in the communication hole and movable, in accordance with change of pressure inside the outflow-side pressure chamber, to a closing position for closing the communication hole and an opening position for opening the communication hole,
wherein
the outflow-side pressure chamber includes, as the liquid outflow hole,
a first outflow hole formed below the communication hole and
a second outflow hole formed above the communication hole, and
as seen from a communication direction of the communication hole, a first line extending in an outflow direction of the liquid from the first outflow hole and a second line extending in an outflow direction of the liquid from the second outflow hole do not coincide with each other.

2. The negative pressure regulation valve according to claim 1,
wherein
the communication hole or a center of the outflow-side pressure chamber as seen from the communication direction is disposed between the first line and the second line.

3. The negative pressure regulation valve according to claim 2,
wherein
the communication hole is formed at the center of the outflow-side pressure chamber as seen from the communication direction.

4. The negative pressure regulation valve according to claim 1,
wherein
the first line and the second line, as seen from the communication direction, are not perpendicular with respect to an inner wall surface of the outflow-side pressure chamber.

5. The negative pressure regulation valve according to claim 4,
wherein
the inner wall surface of the outflow-side pressure chamber is circular-shaped as seen from the communication direction.

6. The negative pressure regulation valve according to claim 1,
wherein
a vector in the outflow direction of the first outflow hole and a vector in the outflow direction of the second outflow hole have rotation directions that coincide with each other when considered as rotation vectors with respect to the communication hole or a center position of the outflow-side pressure chamber.

7. The negative pressure regulation valve according to claim 6,
wherein
the first outflow hole and the second outflow hole are disposed at positions that are point-symmetric with respect to the center position of the outflow-side pressure chamber.

8. The negative pressure regulation valve according to claim 1,
wherein
the first outflow hole is formed at a lower end part of the outflow-side pressure chamber, and the second outflow hole is formed at an upper end part of the outflow-side pressure chamber.

9. The negative pressure regulation valve according to claim 1, further comprising:
a diaphragm portion that constitutes part of the outflow-side pressure chamber and that is displaced by pressure change inside the outflow-side pressure chamber, thereby changing capacity of the outflow-side pressure chamber; and
a biasing member that biases the valve member in a direction toward the closing position,
wherein
the valve member is caused by displacement of the diaphragm portion and a biasing force of the biasing member to move to the closing position and the opening position.

10. An inkjet recording apparatus, comprising:
an ink container that contains ink that is a liquid;
one or more recording heads having a plurality of nozzles that eject the ink; and
the negative pressure regulation valve according to claim 1 connected to an ink flow path between the ink container and the recording heads.

11. The inkjet recording apparatus according to claim 10,
wherein
the ink flow path includes
a first outflow path that communicates with the first outflow hole, and
a second outflow path that communicates with the second outflow hole, and
the first outflow path and the second outflow path communicate with the recording heads.
